(19) United States
(12) Patent Application Publication
(10) Pub. No.: US 2015/0058516 A1
(43) Pub. Date: Feb. 26, 2015

(54) MOTHERBOARD WITH COMPATIBLE CONNECTOR

(71) Applicants: HONG FU JIN PRECISION INDUSTRY (ShenZhen) CO., LTD., Shenzhen (CN); HON HAI PRECISION INDUSTRY CO., LTD., New Taipei (TW)

(72) Inventors: GUI-FU XIAO, Shenzhen (CN); CHENG-FEI WENG, Shenzhen (CN)

(21) Appl. No.: 14/467,051

(22) Filed: Aug. 25, 2014

(30) Foreign Application Priority Data
Aug. 23, 2013 (CN) 2013103717952

(51) Int. Cl. G06F 13/38; G06F 13/40

(52) U.S. Cl. CPC G06F 13/385; G06F 13/4068
USPC 710/313

(57) ABSTRACT

A motherboard includes a connector, an identification module, a Serial Advanced Technology Attachment (SATA) signal module, a Universal Serial Bus (USB) signal module, and a selection module. The connector is used to determine compatibility and connect a SATA-type external device with a SATA connector and a USB-type external device with a USB connector. The identification module is coupled to the connector. The identification module outputs a first signal when the connector is coupled to the SATA-type external device and outputs a second signal when the connector is coupled to the USB-type external device. The selection module connects either the SATA signal module or the USB signal module to the connector as appropriate.

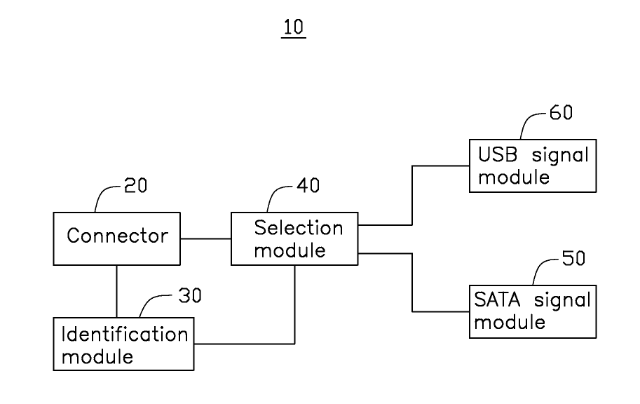

### FIELD

The present disclosure relates to motherboard connectors.

### BACKGROUND

A connector on a motherboard is mainly designed to connect an external device.

### BRIEF DESCRIPTION OF THE DRAWING

Implementations of the present technology will now be described, by way of example only, with reference to the attached FIGURE.

The FIGURE is a block diagram of an embodiment of a motherboard with a compatible connector.

### DETAILED DESCRIPTION

Numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. Also, the description is not to be considered as limiting the scope of the embodiments described herein.

Several definitions that apply throughout this disclosure will now be presented.

The term “coupled” is defined as connected, whether directly or indirectly through intervening components, and is not necessarily limited to physical connections. The connection can be such that the objects are permanently connected or releasably connected. The term “comprising” when utilized, means “including, but not necessarily limited to”; it specifically indicates open-ended inclusion or membership in the so-described combination, group, series and the like.

The motherboard 10 can comprise a connector 20, an identification module 30, a selection module 40, a Serial Advanced Technology Attachment (SATA) signal module 50, and a Universal Serial Bus (USB) signal module 60.

The connector 20 is configured to connect to a first external device or to a second external device. The first external device has a SATA connector and can communicate with the motherboard 10 through the SATA connector. The second external device has a USB connector and can communicate with the motherboard 10 through the USB connector. The SATA signal module 50 can process a first signal from the first external device. The USB signal module 60 can process a second signal from the second external device. The identification module 30 is configured to identify the first or second external device when a coupling is made. The identification module 30 outputs a first signal when the connector 20 is coupled to the first external device. The identification module 30 outputs a second signal when the connector 20 is coupled to the second external device. A signal terminal of the selection module 40 is coupled to the identification module 30. A first terminal of the selection module 40 is coupled to the identification module 30. A second terminal of the selection module 40 is coupled to the USB signal module 60. A third terminal of the selection module 40 is coupled to the SATA signal module 50.

Standard of USB2.0 interface pin definition is shown in table 1:

| Pin number | Signal | Definition |
|---|---|---|
| 1 | VBUS | Voltage |
| 2 | D− | USB2.0 differential pair |
| 3 | D+ | USB2.0 differential pair |
| 4 | GND | Ground |

Standard of SATA interface pin definition is shown in table 2:

| Pin number | Signal | Definition |
|---|---|---|
| 1 | GND | Ground |
| 2 | A+ | Differential pair A |
| 3 | A− | Differential pair A |
| 4 | GND | Ground |
| 5 | B− | Differential pair B |
| 6 | B+ | Differential pair B |
| 7 | GND | Ground |

The connector 20 in the embodiment has first through seventh pins. When the connector 20 is coupled to the first external device, the first pin, the fourth pin, and the seventh pin of the connector 20 are grounded and the second pin, the third pin, the fifth pin, and the sixth pin of the connector 20 transmit signals. When the connector 20 is coupled to the second external device, the first through third pins are idle and the fourth pin is grounded. The fifth pin and the sixth pin transmit signals. The seventh pin is used to output a voltage. The identification module 30 can identify the external device by detecting whether or not there are signals transmitted through the second pin and the third pin of the connector 20. The identification module 30 outputs the first signal when the identification module 30 detects that there are signals transmitted through the second pin and the third pin of the connector 20. The identification module 30 outputs the second signal when the identification module 30 detects no signals transmitted through the second pin and the third pin of the connector 20.

When the signal terminal of the selection module 40 receives the first signal from the identification module 30, the selection module 40 connects the first terminal to the second terminal and disconnects the first terminal from the third terminal. When the signal terminal of the selection module 40 receives the second signal from the identification module 30, the selection module 40 connects the first terminal to the third terminal and disconnects the first terminal from the second terminal.

In use, when the connector 20 is coupled to the first external device, the identification module 30 outputs the first signal to the signal terminal of the selection module 40. The selection module 40 connects the SATA signal module 50 to the first external device. When the connector 20 is coupled to the second external device, the identification module 30 outputs the second signal to the signal terminal of the selection module 40. The selection module 40 connects the USB signal module 60 to the second external device.

What is claimed is:

1. A motherboard, comprising:
a connector configured to compatibly connect to one of a first external device and a second external device, the first external device having a Serial Advanced Technology Attachment (SATA) connector and the second external device having a Universal Serial Bus (USB) connector;
an identification module coupled to the connector, wherein the identification module is configured to output a first signal when the connector is coupled to the first external device, and output a second signal when the connector is coupled to the second external device;
a SATA signal module and a USB signal module; and
a selection module, wherein a signal terminal of the selection module is coupled to the identification module, a first terminal of the selection module is coupled to the connector, a second terminal of the selection module is coupled to the USB signal module, a third terminal of the selection module is coupled to the SATA signal module, configured such thatwhen the signal terminal of the selection module receives the first signal from the identification module, the selection module connects the first terminal to the second terminal and disconnects the first terminal from the third terminal; and further configured such that when the signal terminal of the selection module receives the second signal from the identification module, the selection module connects the first terminal to the third terminal and disconnects the first terminal from the second terminal.

2. The motherboard of claim 1, wherein the connector comprises first to seventh pins.

3. The motherboard of claim 2, wherein the identification module outputs the first signal when the identification module detects that there are signals transmitted through the second pin and the third pin of the connector, and the identification module outputs the second signal when the identification module detects that there are no signals transmitted through the second pin and the third pin of the connector.

4. The motherboard of claim 1, wherein the SATA signal module can process a first signal from the first external device, the USB signal module can process a second signal from the second external device.
